(19) United States
(12) Patent Application Publication
(10) Pub. No.: US 2006/0074711 A1
(43) Pub. Date: Apr. 6, 2006

(54) System and method for handling multiple radiology applications and workflows

(76) Inventors: Prakash Mahesh, Schaumburg, IL (US); Mark Ricard, Naperville, IL (US)

Correspondence Address: MCANDREWS HELD & MALLOY, LTD, 500 WEST MADISON STREET, SUITE 3400, CHICAGO, IL, 60661, US

(21) Appl. No.: 10/956,434

(22) Filed: Oct. 1, 2004

(51) Int. Cl. G06Q 10/00

(52) U.S. Cl. 705/2

(57) ABSTRACT

Certain embodiments of the present invention provide a method and system for using medical perspectives to improve management of multiple applications and workflows. In an embodiment, the system includes a plurality of medical applications providing information to a user, a plurality of perspectives, and a medical perspectives manager for associating one or more applications with a perspective. The medical perspectives manager allows a user to access one or more associated applications using the perspective. Each perspective saves a relation with at least one of the medical applications. In an embodiment, the perspectives save component positioning and interactions based on workflow. The plurality of medical applications may include a plurality of information systems and/or imaging systems, for example. In an embodiment, each perspective personalizes a display of information to present relevant information for a user, a condition, and/or a system.

### BACKGROUND OF THE INVENTION

The present invention generally relates to perspectives in a healthcare environment. In particular, the present invention relates to use of medical perspectives to improve management of multiple applications and workflows.

A clinical or healthcare environment is a crowded, demanding environment that would benefit from organization and improved ease of use of imaging systems, data storage systems, and other equipment used in the healthcare environment. A healthcare environment, such as a hospital or clinic, encompasses a large array of professionals, patients, and equipment. Personnel in a healthcare facility must manage a plurality of patients, systems, and tasks to provide quality service to patients. Healthcare personnel may encounter many difficulties or obstacles in their workflow.

A variety of distractions in a clinical environment may frequently interrupt medical personnel or interfere with their job performance. Furthermore, workspaces, such as a radiology workspace, may become cluttered with a variety of monitors, data input devices, data storage devices, and communication device, for example. Cluttered workspaces may result in efficient workflow and service to clients, which may impact a patient's health and safety or result in liability for a healthcare facility. Data entry and access is also complicated in a typical healthcare facility.

Thus, management of multiple and disparate devices, positioned within an already crowded environment, that are used to perform daily tasks is difficult for medical or healthcare personnel. Additionally, a lack of interoperability between the devices increases delay and inconvenience associated with the use of multiple devices in a healthcare workflow. The use of multiple devices may also involve managing multiple logons within the same environment. A system and method for improving ease of use and interoperability between multiple devices in a healthcare environment would be highly desirable.

In a healthcare environment involving extensive interaction with a plurality of devices, such as keyboards, computer mousing devices, imaging probes, and surgical equipment, repetitive motion disorders often occur. A system and method that eliminate some of the repetitive motion in order to minimize repetitive motion injuries would be highly desirable.

Healthcare environments, such as hospitals or clinics, include clinical information systems, such as hospital information systems (HIS) and radiology information systems (RIS), and storage systems, such as picture archiving and communication systems (PACS). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during surgery, medical personnel may access patient information, such as images of a patient's anatomy, that are stored in a medical information system. Alternatively, medical personnel may enter new information, such as history, diagnostic, or treatment information, into a medical information system during an ongoing medical procedure.

In current information systems, such as PACS, information is entered or retrieved using a local computer terminal with a keyboard and/or mouse. During a medical procedure or at other times in a medical workflow, physical use of a keyboard, mouse or similar device may be impractical (e.g., in a different room) and/or unsanitary (i.e., a violation of the integrity of an individual's sterile field). Re-sterilizing after using a local computer terminal is often impractical for medical personnel in an operating room, for example, and may discourage medical personnel from accessing medical information systems. Thus, a system and method providing access to a medical information system without physical contact would be highly desirable to improve workflow and maintain a sterile field.

Imaging systems are complicated to configure and to operate. Often, healthcare personnel may be trying to obtain an image of a patient, reference or update patient records or diagnosis, and ordering additional tests or consultation. Thus, there is a need for a system and method that facilitate operation and interoperability of an imaging system and related devices by an operator.

In many situations, an operator of an imaging system may experience difficulty when scanning a patient or other object using an imaging system console. For example, using an imaging system, such as an ultrasound imaging system, for upper and lower extremity exams, compression exams, carotid exams, neo-natal head exams, and portable exams may be difficult with a typical system control console. An operator may not be able to physically reach both the console and a location to be scanned. Additionally, an operator may not be able to adjust a patient being scanned and operate the system at the console simultaneously. An operator may be unable to reach a telephone or a computer terminal to access information or order tests or consultation. Providing an additional operator or assistant to assist with examination may increase cost of the examination and may produce errors or unusable data due to miscommunication between the operator and the assistant. Thus, a method and system that facilitate operation of an imaging system and related services by an individual operator would be highly desirable.

A reading, such as a radiology or cardiology procedure reading, is a process of a healthcare practitioner, such as a radiologist or a cardiologist, viewing digital images of a patient. The practitioner performs a diagnosis based on a content of the diagnostic images and reports on results electronically (e.g., using dictation or otherwise) or on paper. The practitioner, such as a radiologist or cardiologist, typically uses other tools to perform diagnosis. Some examples of other tools are prior and related prior (historical) exams and their results, laboratory exams (such as blood work), allergies, pathology results, medication, alerts, document images, and other tools.

Depending upon vendors and systems used by a practitioner, practitioners, such as radiologists or cardiologists, have only a few options to reference the tools available. First, a request for information from the available tools may be made in paper form. Second, a practitioner may use different applications, such as a radiologist information system (RIS), picture archiving and communication system (PACS), electronic medical record (EMR), healthcare information system (HIS), and laboratory information system (LIS), to search for patients and examine the information electronically.

In the first case, the practitioner shifts his or her focus away from a reading workstation to search and browse through the paper, which in most cases includes many pieces of paper per patient. This slows down the practitioner and introduces a potential for errors due to the sheer volume of paper. Thus, a system and method that reduce the amount of paper being viewed and arranged by a practitioner would be highly desirable.

In the second case, electronic information systems often do not communicate well across different systems. Therefore, the practitioner must log on to each system separately and search for the patients and exams on each system. Such a tedious task results in significant delays and potential errors. Thus, a system and method that improve communication and interaction between multiple electronic information systems would be highly desirable.

Additionally, even if systems are integrated using mechanisms such as Clinical Context Object Workgroup (CCOW) to provide a practitioner with a uniform patient context in several systems, the practitioner is still provided with too much information to browse through. Too much information from different applications is provided at the same time and slows down the reading and analysis process. There is a need to filter out application components that a user will not need in a routine workflow. Thus, a system and method which manage information provided by multiple systems would be highly desirable.

Thus, there is a need for a system and method to improve workflow and productivity using medical perspectives to improve management of multiple applications and workflows.

### BRIEF SUMMARY OF THE INVENTION

Certain embodiments of the present invention provide a method and system for using medical perspectives to improve management of multiple applications and workflows. In an embodiment, the system includes a plurality of medical applications providing information to a user, a plurality of perspectives, and a medical perspectives manager for associating one or more applications with a perspective. The medical perspectives manager allows a user to access one or more associated applications using the perspective. Each perspective saves a relation with at least one of the medical applications. In an embodiment, the perspectives save component positioning and interactions based on workflow. The plurality of medical applications may include a plurality of information systems and/or imaging systems, for example. In an embodiment, each perspective personalizes a display of information to present relevant information for a user, a condition, and/or a system.

In an embodiment, the system also includes an authentication module for authenticating access to the medical perspectives manager, one or more of the perspectives, and/or one or more of the medical applications, for example. The system may include a rules engine including at least one rule governing availability and/or presentation of information. The system may also include a context manager for obtaining information from the plurality of information sources based on a query and filtering the information based on the rule(s).

Certain embodiment of a method for providing medical perspectives to manage multiple applications and workflows include storing at least one perspective including information in a certain configuration, allowing a selection of a perspective to view information, and providing access to the information through the selected perspective. The perspective(s) may save positioning and interaction between components based on workflow, for example. The information may include an application, an image, and/or an information system, for example. Access to the information may be provided using context sharing, for example.

In an embodiment, the method further includes allowing a change from one perspective to another perspective. The method may also include filtering the information based on one or more rules. In an embodiment, access to a perspective is authenticated.

In an embodiment, a method for accessing medical information includes selecting a perspective in which to view a display, wherein the perspective provides positions and/or relationships between components on the display. The method also includes accessing information from at least one component via the perspective. In an embodiment, the components include an application, an image, a report, a system, and data, for example. The method may also include creating the perspective. Additionally, the method may include switching to a second perspective. In an embodiment, rules may be applied to filter the information.

In an embodiment, a computer-readable storage medium includes a set of instructions for a computer. The set of instructions include a perspective creation routine for creating a medical perspective representing a configuration and a relationship of components in a system, wherein each component corresponds to at least one information source. The set of instructions also include a perspectives management routine for selecting among a plurality of medical perspectives.

### BRIEF DESCRIPTION OF SEVERAL VIEWS OF THE DRAWINGS

FIG. 1 illustrates a medical application perspectives system used in accordance with an embodiment of the present invention.

FIG. 2 illustrates a flow diagram for a method for managing multiple applications and workflows in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

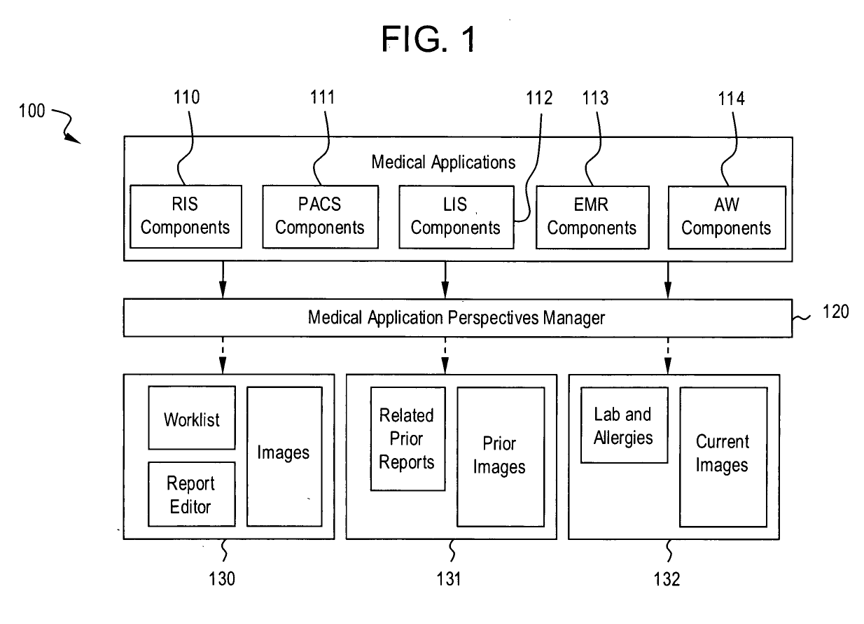

FIG. 1 illustrates a medical application perspectives system 100 used in accordance with an embodiment of the present invention. The system 100 includes a plurality of medical applications 110, 111, 112, 113, 114, a medical application perspectives manager 120, and a plurality of medical perspectives 130, 131, 132. The components of the system 100 may communicate via wired and/or wireless connections on one or more processing units, such as computers, medical systems, storage devices, custom processors, and/or other processing units.

The plurality of medical applications 110-114 may be associated with one or more imaging modalities, for example. The applications 110-114 may include non-medical as well as medical software applications. The applications may include RIS components 110, PACS components 111, LIS components 112, EMR components 113, and AW (Multimodality Advantage Workstation) components 114, for example.

The plurality of medical perspectives 130-132 are software components that save visual component positioning and interactions between the medical applications 110-114 based on workflow. Medical application perspectives 130-132 are a mechanism used to create a plurality of benefits for users of the system 100. For example, perspectives 130-132 provide patient context sharing between different applications 110-114 and components that a user views. Additionally, for example, perspectives 130-132 provide an ability to switch between different configurations or perspectives 130-132 based on which applications 110-114 and components a user wishes to view at any given point. Furthermore, for example, perspectives 130-132 provide an ability to store or “remember” specific workflow steps. Perspectives 130-132 provide a mechanism to save and display information relevant to a particular user, group, and/or function, for example.

In FIG. 1, perspectives 130-132 provide examples of perspectives that may be saved by and/or for one or more users. For example, a perspective may include viewing an exam worklist on a color monitor, one or more images displayed on one or more diagnostic monitors, and a report editor on the bottom of the color monitor. For example, another perspective may include viewing related prior report(s) on the color monitor, related prior image(s) on one diagnostic monitor, and current image(s) on another diagnostic monitor. For example, a perspective may show viewing all labs and allergies for a period of time (e.g., two months) for a patient on the color monitor and viewing current image(s) on the diagnostic monitor(s). As another example, a perspective may include viewing any maximum intensity projection/multiplanar reconstruction (MIP/MPR) image set for a current exam on a diagnostic monitor.

The medical application perspectives manager 120 may be an integrated or standalone software and/or hardware unit for coordinating and controlling one or more perspectives 130-132 and applications 110-114. Users of the system 100 may “switch to” or “be assigned” a medical perspective 130-132 on the fly via the medical application perspectives manager 120. Based on the available perspectives 130-132, a user may toggle between the perspectives 130-132 to read an exam or other data. A user may toggle between available perspectives 130-132 via the medical application perspectives manager 120 using a mousing device, keyboard shortcuts, gaze tracking, and/or voice command, for example. In an embodiment, the perspectives manager 120 may include a database to store perspectives 130-132 and related information. For example, specific workflows of individual radiologists and/or cardiologists may be stored in the database so that each radiologists/cardiologists uses the same workflow through the same sequence of perspectives wherever the user logs in to the system 100. Thus, a user has the advantage of reading exams and other data quickly and efficiently on any diagnostic workstation, for example.

In an embodiment, the medical applications perspective manager 120 includes and/or communicates with an authentication unit. The authentication unit may include software and/or hardware to verify a user's right to access one or more of the applications 110-114, perspectives 130-132 and/or manager 120. In an embodiment, authentication via the perspectives manager 120 allows access to relevant applications 110-114 and perspectives 130-132 for a user. For example, if a user logs on to a system running the perspectives manager 120, based on previous saving of a default perspective, the user is logged on automatically into RIS, PACS, and EMR systems.

In operation, a user, such as a radiologist or cardiologist, accesses the perspectives manager 120 via a RIS/PACS system, for example. RIS and PACS systems may be integrated into a single system, for example, with shared patient and exam contexts. Thus, the user access relevant prior history for a patient (e.g., images and reports). Using different perspectives the user has already created, the user may switch between perspectives to view desired information. The medical application perspectives 130-132 may be delivered to the user in a variety of ways. For example, perspectives may be delivered via a preselected set of components and/or workflows from a medical software and/or hardware provider. Perspectives may also be delivered via perspectives created by a system administrator. Additionally, a user may dynamically create perspectives during operation of the system 100 (i.e., “on the fly”). Thus, the user may select components and/or applications for display in viewable areas of one or more monitors based on workflow. The information/configuration may then be saved in one or more perspectives. The user may toggle between perspectives to read an exam or other data on a variety of devices such as displays and/or printers. The user may save perspectives, exams, reports, and/or other data via the manager 120.

In an embodiment, a plurality of applications may be providing information to a radiologist or cardiologist for diagnosis of a patient. One or more displays available to the radiologist/cardiologist may not have enough screen space to display all of the information. Additionally, displaying all of the available information would be too crowded to be useful. Even if information is filtered with rules, too much information may still remain. Thus, the manager 120 and the system 100 allow a user to apply medical perspectives on a workstation to view information from a plurality of applications and systems. One perspective may be set up to show images and/or examination results from radiology, for example. Another perspective may be set up to show images and/or examination results from cardiology, for example. Another perspective may be set up to show images and/or examination results from imaging, for example.

In an embodiment, the applications 110-114, manager 120, and perspectives 130-132 may be integrated in a universal workstation providing a plurality of diagnostic viewing applications and other applications. The workstation may provide dozens of medical applications with hundreds of components and workflows, for example. Perspectives 130-132 and perspectives manager 120 may be used to filter out application components that a user does not use in a routine workflow.

Perspectives may be used to logically group different applications 110-114. Rules, configuration options, and/or other criteria may be defined in order to define perspectives 130-132. Perspectives may be defined for images, examination results, laboratory data, patient history data, structured report data, DICOM data, and/or other data, for example. In an embodiment, perspectives 130-132 do not eliminate or change information but rather order information in a certain way. For example, information important to a user may be displayed first, with additional information available via different perspectives. In an embodiment, the manager 120 may “learn” through user selection or other configuration information, for example, to create perspectives automatically without manual intervention by the user.

In an embodiment, the manager 120 may work together with a rules-based context manager to filter and display information. One example of a rules-based context manager is described in a U.S. Patent Application filed on Oct. 1, 2004, entitled “System and Method for Rules-Based Context Management in Radiology and Cardiology Diagnostic Reading”, with inventor Prakash Mahesh, which is herein incorporated by reference in its entirety.

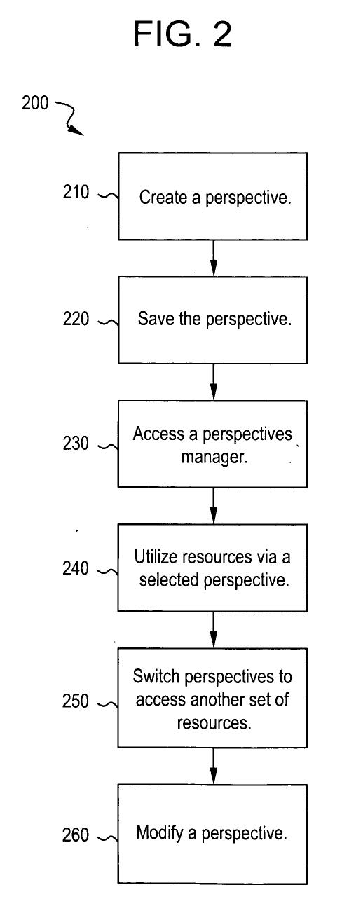

FIG. 2 illustrates a flow diagram for a method 200 for managing multiple applications and workflows in accordance with an embodiment of the present invention. First, at step 210, a perspective is created. For example, a perspective may be created by a system administrator, by a user, and/or automatically by a software program. A perspective may capture and store workflow, applications, reports, images, and/or other information, for example. A perspective may be created for a particular user or group of users (e.g., surgeons, radiologists, cardiologists, etc.), for a particular use or group of uses (e.g., image-guided surgery, radiology reading, structured reporting, examination, etc.), for a particular modality (e.g., x-ray, ultrasound, magnetic resonance imaging, etc.), and/or for a particular platform (e.g., a PACS, an integrated RIS/PACS, an imaging system, etc.), for example.

Then, at step 220, the perspective is saved. The perspective may be saved in volatile and/or non-volatile storage, for example. In an embodiment, the perspective may be saved in association with a particular user, group of users, application, and/or platform, for example. The perspective saves visual component positioning and interactions based on workflow, for example.

Next, at step 230, a user accesses a medical perspectives manager, such as the manager 120. The user and/or software may select a perspective to open using the perspectives manager. In an embodiment, certain restrictions and/or permissions may limit which perspectives a particular user may access. In an embodiment, a user is authenticated (e.g., through a password, passcode, and/or biometric identification) at the manager. The manager then automatically authenticates the user at the relevant applications and/or systems associated with the selected perspective. Alternatively, authentication may be performed separate for each application and/or system access through the perspective.

At step 240, the user utilizes resources, such as applications, systems, workflows, and/or data, via the selected perspective. For example, the user views images, laboratory results, and patient histories through the selected perspective. The perspective allows information to be customized for the particular user. Then, at step 250, the user may switch between perspectives to access another set of resources, such as information, applications, and/or workflows. For example, the user may switch between a perspective showing images and radiology examination results and a perspective showing an examination worklist and report editor. Next, at step 260, a user, system administrator, and/or software, for example, may modify a perspective.

In an embodiment, the method 200 may also include filtering information available in one or more perspectives based on rules, such as context-based rules. The rules may be used to further reduce and/or tailor information presented to a user based on one or more defined criteria. Ordering and reducing information improves user workflow and increases productivity.

Thus, certain embodiments facilitate increased productivity of a radiologist, cardiologist, or other user reading exams that use relevant information from other information systems. Increased productivity includes a speed in which a diagnosis may be performed and an accuracy of reports produced based on the diagnosis. Workflow steps may be saved in the form of perspectives. A user may seamlessly toggle between perspectives. In certain embodiments, a user may toggle between perspectives without touching a keyboard or mouse using a technique such as voice command and/or gaze tracking. Alternatively, a user may toggle between perspectives using a single click from a mousing device or a button. Thus, certain embodiments allow a user to view only the information he or she wants in the workflow he or she wants. Certain embodiments allow a user to manage the number of applications being accessed at a given time.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A system for using medical perspectives to improve management of multiple applications and workflows, the system comprising:
a plurality of medical applications providing information to a user;
a plurality of perspectives, each perspective saving a relation with at least one of the medical applications; and
a medical perspectives manager for associating at least one application with a perspective, wherein the medical perspectives manager allows a user to access the at least one associated application using the perspective.

2. The system of claim 1, wherein the plurality of perspectives save component positioning and interactions based on workflow.

3. The system of claim 1, wherein the plurality of medical applications includes a plurality of information systems.

4. The system of claim 1, wherein the plurality of medical applications includes a plurality of imaging systems.

5. The system of claim 1, further comprising an authentication module for authenticating access to at least one of the medical perspectives manager, at least one of the plurality of perspectives, and at least one of the plurality of medical applications.

6. The system of claim 1, further comprising:
a rules engine including at least one rule governing at least one of availability and presentation of information; and
a context manager for obtaining information from the plurality of information sources based on a query and filtering the information based on the at least one rule.

7. The system of claim 1, wherein each perspective personalizes an information display to present relevant information for at least one of a user, a condition, and a system.

8. A method for providing medical perspectives to manage multiple applications and workflows, the method comprising:
storing at least one perspective including information in a certain configuration;
allowing a selection of a perspective to view information; and
providing access to the information through the selected perspective.

9. The method of claim 8, wherein the at least one perspective saves positioning and interaction between components based on workflow.

10. The method of claim 8, wherein the information includes at least one of an application, an image, and an information system.

11. The method of claim 8, further comprising allowing a change from one perspective to another perspective.

12. The method of claim 8, further comprising filtering the information based on at least one rule.

13. The method of claim 8, further comprising authenticating access to the perspective.

14. The method of claim 8, wherein the providing step further comprises providing access to the information using context sharing.

15. A method for accessing medical information, the method comprising:
selecting a perspective in which to view a display, wherein the perspective provides at least one of positions and relationships between components on the display; and
accessing information from at least one component via the perspective.

16. The method of claim 15, wherein the components comprise at least one of an application, an image, a report, a system, and data.

17. The method of claim 15, further comprising creating the perspective.

18. The method of claim 15, further comprising switching to a second perspective.

19. The method of claim 15, further comprising applying rules to filter the information.

20. A computer-readable storage medium including a set of instructions for a computer, the set of instructions comprising:
a perspective creation routine for creating a medical perspective representing a configuration and a relationship of components in a system, wherein each component corresponds to at least one information source;
a perspectives management routine for selecting among a plurality of medical perspectives.
